(19) United States
(12) Patent Application Publication
(10) Pub. No.: US 2004/0127342 A1
(43) Pub. Date: Jul. 1, 2004

(54) Glass composition of a substrate for display

(75) Inventors: Chin Chao Liang, Hsinchu Hsien (TW); I Po Kuo, Taipei (TW); Hua Ching Tan, Taoyuan Hsien (TW)

Correspondence Address: BACON & THOMAS, PLLC, 625 SLATERS LANE, FOURTH FLOOR, ALEXANDRIA, VA, 22314

(73) Assignee: China Optoelectronics Technology Corp., Taoyuan (TW)

(21) Appl. No.: 10/329,452

(22) Filed: Dec. 27, 2002

(51) Int. Cl. C03C 3/091; C03C 3/093

(52) U.S. Cl. 501/66; 501/67

(57) ABSTRACT

The present invention is to provide glass composition of a substrate for display consisting essentially of, as calculated in weight percent on an oxide basis, 56.0˜62.0% SiO sub.2, 13.0˜18.0% Al sub.2 O sub.3, 9.0˜13.5% B sub.2 O sub.3, 1.0˜8.0% SrO, 0.1˜8.0% BaO, 3.5-8.5% CaO, 0˜1.0% MgO, 0.1˜1.5% ZnO, 0.1˜1.5% ZrO sub.2 and 0˜1.0% BeO, provided that the total weight percent of CaO, MgO, ZnO, ZrO sub.2 and BeO is preferably within 4.0˜9.0%.

### BACKGROUND OF THE INVENTION

1. Field of the Invention

The invention relates to a family of glass composition of a substrate with thickness between 0.2˜1.2 mm for flat display panel, more specifically relates to a substrate suitable for manufacturing liquid crystal display panels.

2. Prior Art of the Invention

Traditionally, the substrates being used for manufacturing active matrix liquid crystal displays, such as thin film transistor (TFT) display panels and the similar, all belong to an aluminosilicate glass. This kind of substrate consists of a minor volume of composition of alkali metal oxide and can be used for manufacturing flat panels by utilizing a float or pull-down forming process, wherein the float forming process is suitable for manufacturing flat panels in a production volume above 30 tons per day, whereas the pull-down forming process is suitable for manufacturing flat panels in a production volume between 3˜10 tons per day. Generally speaking, when using pull-down forming process to manufacture flat panels, the liquidus glass melt with extremely high temperature will flow sequentially through the glass melting stove, purifying tunnel and cooling pipe, and then flows into a dispensing tunnel for equally dispensing the glass melt. After the glass melt flows into a pull-down apparatus, and the glass melt is pulled by the pull-down apparatus and cooled down to form a flat panel. Since the pull-down forming process is reliable in mass production of thin film glass panel, it is suitable to be the process for manufacturing substrate of liquid crystal display panel. Besides, in the pull-down forming process, while the glass melt flowing through the glass melting stove and purifying tunnel, the glass melt is of an extremely high temperature and is liquidus. After the glass melt flowing through the cooling pipe, the cooling pipe will cool the glass melt flowing to the dispensing apparatus down to the temperature suitable for forming the flat panel, i.e. the temperature enabling to maintain the viscosity of glass melt within 10^{4.6}˜10^{5.2} poise.

In general, while the temperature of the glass melt decreases, it is very easy to cause devitrification inside the glass being formed. The highest temperature being used to define whether the devitrification will occur inside the glass is called glass liquidus temperature (T_{L}). Thus, when the glass melt is of the temperature higher than the glass liquidus temperature (T_{L}), the devitrification won't happen therein even after a long period of heating process. Usually, the glass forming temperature approaches the glass liquidus temperature. However, if the glass forming temperature is below the glass liquidus temperature under a long period of time, it will cause the glass being formed having devitrification therein, which will produce unexpected defects inside the glass and eventually reduce the good quality rate. Therefore, in the glass forming process, it is very important to separate the glass liquidus temperature and the glass forming temperature with an appropriate range. According to the practical experiences, the glass forming temperature should be greater than the glass liquidus temperature by at least 40° C. in order to prevent the glass from devitrification in the forming process.

Conventionally, during using pull-down forming process to manufacture an aluminosilicate glass, the temperature is controlled within 1085˜1250° C. Therefore, in order to decrease the defects inside the glass or on the surface thereof caused by the devitrification, two methods are usually implemented through increasing the glass forming temperature or decreasing the glass liquidus temperature, in order to let the glass forming temperature be greater than the glass liquidus temperature by at least 40° C. As to the method of increasing the glass forming temperature, since viscosity of the glass melt will decreases while the temperature increases, increasing the forming temperature will cause the glass melt being formed having a lower viscosity, which is unable to maintain the shape of product in accuracy. Besides, increasing the glass forming temperature will also cause the cooling pipe, dispensing tunnel and pulling apparatus being operated in a high temperature environment, which not only increases the energy consumption, but also decreases the use lives of the devices. Thus, when the glass melt or the apparatuses are operated under such a high temperature environment, impurities or other contaminants will easily precipitate into the flat panel glass being formed and result in unable to raise the good quality rate. Therefore, in practice, the method of decreasing the glass liquidus temperature is more preferable to be adopted than the method of increasing the glass forming temperature.

While adjusting the glass liquidus temperature, it is usually by adjusting the compositions of the glass to lower down the glass liquidus temperature less than the low limit forming temperature 1085° C. by at least 40° C. or more. However, after the compositions of the glass being changed, along with the change of the glass liquidus temperature, other important properties, such as thermal expansion coefficient, strain point and density etc., will also change together. Sometimes, some of the properties will turn deteriorated to a situation unable to be normally utilized in a display panel. Therefore, how to adjust the compositions of the glass in order not only to lower down the glass liquidus temperature, but also at the same time to maintain the other physical properties under a normal condition not being severely deteriorated, will be a crucial point for obtaining a desired combination of compositions thereof.

In addition, with respect to the substrate glass being utilized in liquid crystal display panel, especially for manufacturing thin film transistor display panel, the requirements of the physical properties are strict, such as thermal expansion coefficient, strain point and density etc., should also be deemed as an important factor being put into consideration and evaluation. In general, the thermal expansion coefficient of a substrate glass for manufacturing thin film transistor display panel should be less than 40×10⁻⁷/° C., if greater than this, will badly effect the accuracy of the subsequent manufacturing process and cause the substrate difficult to be assembled. The strain point of a substrate glass for manufacturing thin film transistor display panel should be greater than 650° C., if less than this, will also badly effect the accuracy of the subsequent manufacturing process and cause the positioning of the photolithography etching biased, more severely will cause the circuit implemented thereon broken or shut down, which will deteriorate the electric performance. The density of a substrate glass for manufacturing thin film transistor display panel should generally be less than 2.55 g/cm³, if greater than this, will increase the weight of the display panel and cause it unable to be utilized in a portable product.

Within the recent years, lots of designers and manufacturers dedicate into the field in developing a variety of new compositions of substrate glass for manufacturing display panel, such as U.S. patents of the numbers U.S. Pat. Nos. 5,811,361, 5,851,939 and 6,060,168. According to the compositions disclosed in these patents, the substrate glass still has glass liquidus temperature greater than 1090° C. Therefore, while the substrate glass disclosed in these patents being formed under pull-down forming process, the disadvantages mentioned above will apparently occur.

### SUMMARY OF THE INVENTION

In respect of the above-mentioned problems existing in the substrate glass used in the traditional liquid crystal displays, the inventor develops a family of glass composition of a substrate for flat panel displays, of which the glass liquidus temperature is below 1045° C. and all other important properties, such as thermal expansion coefficient, strain point and density etc., are maintained similar to those of the general aluminosilicate glass. An object of the present invention is to provide glass composition of a substrate for display consisting essentially of, as calculated in weight percent on an oxide basis, of 56.0%˜62.0% SiO sub.2, 13.0%˜18.0% Al sub.2 O sub.3, 9.0%˜13.5% B sub.2 O sub.3, 1.0%˜8.0% SrO and 0.1% 8.0% BaO. Other five compositions including therein are CaO, MgO, ZnO, ZrO sub.2 and BeO, each of them has only minor percent comparing with the total weight, however, they devote very crucial influences to the viscosity and melting point of the glass melt. The weight percents of CaO, MgO, ZnO, ZrO sub.2 and BeO are respectively 3.5%˜8.5%, 0%˜1.0%, 0.1%˜1.5%, 0.1%˜1.5% and 0%˜1.0%, provided that the total weight percent of CaO, MgO, ZnO, ZrO sub.2 and BeO is preferably within 4.0˜9.0%.

The above objects, features and advantages of the present invention will become apparent from the following detailed description taken with the accompanying tables.

### DESCRIPTION OF THE INVENTION

The present invention is to provide a family of glass composition of a substrate for flat panel displays, consisting essentially of the following materials in weight percent as calculated on an oxide basis from the glass batches:

1) 56.0˜62.0% SiO sub.2;

2) 13.0˜18.0% Al sub.2 O sub.3,

3) 9.0˜13.5% B sub.2 O sub.3;

4) 1.0˜8.0% SrO;

5) 0.1˜8.0% BaO;

6) 3.5˜8.5% CaO;

7) 0˜1.0% MgO;

8) 0.1˜1.5% ZnO;

9) 0.1˜1.5% ZrO sub.2;

10) 0˜1.0% BeO;

11) the total weight percent of CaO, MgO, ZnO, ZrO sub.2 and BeO is preferably within 4.0˜9.0%.

In the present invention, since the weight percents of all the compositions, depending on their physical properties, will cause different degrees of influences to the properties, structures and productions of the substrate glass, the weight percents of the compositions should therefore be limited within an appropriate range. Among those compositions, SiO sub.2, Al sub.2 O sub.3, B sub.2 O sub.3, SrO and BaO are the primary compositions of the substrate glass, which not only have greater weight percents, but also have great influences to the substrate glass on its properties, structures and productions. As to the above five compositions, SiO sub.2 is the main material to form the glass network, of which the weight percent is preferably within 56.0˜62.0%. If the weight percent of SiO sub.2 is below 56.0%, the devitrification will easily occur in the substrate glass being manufactured. On the other hand, if the weight percent of SiO sub.2 is greater than 62.0%, the melting temperature of the glass will turn to be too high to be manufactured by an ordinary melting crucible and the glass being manufactured will also easily have devitrification inside. Al sub.2 O sub.3 is utilized to enhance the strength of the structure, of which the weight percent is preferably within 13.0˜18.0%. If the weight percent of Al sub.2 O sub.3 is below 13.0%, the substrate glass being manufactured will easily have devitrification inside and be eroded by moisture vapor or chemical solutions in the environment. On the other hand, if the weight percent of Al sub.2 O sub.3 is greater than 18.0%, it will cause the melting temperature going too high to be manufactured by an ordinary melting crucible. B sub.2 O sub.3 is utilized to lower down the viscosity of the glass melt while being melted in the manufacturing process, of which the weight percent is preferably within 9.0˜13.5%. If the weight percent of B sub.2 O sub.3 is below 9.0%, the viscosity of the glass melt won't effectively go down. However, if the weight percent of B sub.2 O sub.3 is greater than 13.5%, it will greatly reduce the value of strain point and is disadvantageous to the subsequent manufacturing. The weight percent of SrO is preferably within 1.0˜8.0%, if the weight percent of SrO is below 1.0%, the glass being manufactured will have devitrification inside. If the weight percent of SrO is greater than 8.0%, the density of the glass will be too great to be disadvantageous to the application of product. The function of BaO is similar to SrO, of which the weight percent is preferably within 0.1˜8.0%. If the weight percent of BaO is below 0.1%, it will cause the glass being manufactured having devitrification inside. In the contrary, if the weight percent of BaO is greater than 8.0%, the density of the glass will be too great and the value of strain point will be obviously reduced.

Among the compositions of the glass according to the present invention, except the above five compositions (i.e. SiO sub.2, Al sub.2 O sub.3, B sub.2 O sub.3, SrO and BaO), the glass further includes additional five compositions, namely CaO, MgO, ZnO, ZrO sub.2 and BeO. Though these five additional compositions have less weight percent in comparing with the total weight thereof, they are still very important to the viscosity and melting point of the glass melt while being melted in the manufacturing process. Among the additional compositions, CaO is utilized to enhance the melting of the glass, of which the weight percent is preferably within 3.5˜8.5%. If the weight percent of CaO is below 3.5%, the viscosity of the glass melt won't be effectively reduced. However, if the weight percent of CaO is greater than 8.5%, it will cause the glass being manufactured having devitrification inside, and increase the expansion coefficient which will be disadvantageous to the subsequent manufacturing process. MgO is utilized to reduce the viscosity of the glass melt while being melt in the manufacturing process in order to reduce the vapor or impurity contained in the glass melt, of which the weight percent is preferably within 0˜1.0%. If the weight percent of MgO is greater than 1.0%, it will cause the glass being manufactured having devitrification inside. ZnO is utilized to enhance the melting of the glass, of which the weight percent is preferably within 0.1˜1.5%. If the weight percent of ZnO is below 0.1%, the melting effect of the glass melt won't be apparent. On the other hand, if the weight percent of ZnO is greater than 1.5%, it will cause the glass being manufactured having devitrification inside and greatly reduce the value of strain point. ZrO sub.2 is utilized to reduce the viscosity of the glass melt in order to enhance the melting effect, of which the weight percent is preferably within 0.1˜1.5%, if the weight percent of ZrO sub.2 is below 0.1%, it won't enhance the melting effect. On the contrary, if the weight percent of ZrO sub.2 is greater than 1.5%, it will cause the glass being manufactured having devitrification inside. BeO is also utilized to enhance the melting effect of the glass, of which the weight percent is preferably within 0˜1.0%. If the weight percent of BeO is greater than 1.0%, it will also cause the glass being manufactured having devitrification inside.

It should be noted that, though the above mentioned five additional compositions are utilized to improve the melting effect and adjusting the expansion coefficient of the glass, the total weight percent of CaO, MgO, ZnO, ZrO sub.2 and BeO should be preferably limited within 4.0˜9.0%. If the total weight percent of CaO, MgO, ZnO, ZrO sub.2 and BeO is below 4.0%, the melting temperature of the glass will go too great. On the contrary, if the total weight percent of CaO, MgO, ZnO, ZrO sub.2 and BeO is greater than 9.0%, it will cause the glass being manufactured having devitrification inside, and the expansion coefficient of the glass will turn too great.

While implementing the present invention, it should be first uniformly mixing all of the above-mentioned compositions together, and then putting the mixed material into a glass melting crucible. Until the mixed material being melted into glass melt and the temperature of the glass melt being reduced to a range necessary for forming substrate, i.e. the temperature maintaining the viscosity within 10^{4.6}˜10^{5.2} poise, it is then utilizing the pull-down forming process to form substrate with a predetermined thickness and, after the temperature of the substrate being cooled down, cutting the substrate into pieces of the size appropriate for manufacturing the liquid crystal display. A variety of embodiments of the invention are described hereinafter, of which the compositions of different weight percents are mixed together for manufacturing different substrates according to the above forming procedures. The differences of the properties of the expansion coefficients, values of strain point, densities and glass liquidus temperatures between the substrates manufactured by the embodiments are also listed below:

In Table 1, sets forth exemplary glass compositions in weight percent, as calculated on an oxide basis from the glass batches it shows the compositions and properties of the substrates manufactured by six embodiments of the present invention (from embodiment 1 to embodiment 6). In Table 2, it shows the substrates manufactured by six comparative examples (from example 7 to example 12) with the compositions and properties different from those claimed in the present invention. All of the substrates shown in Table 1 and 2 are manufactured by following the same procedures, mixing the compositions uniformly in accordance with the weight percents listed in the tables, melting the mixed material in a platinum crucible for 6 to 8 hours under the temperatures between 1600˜1650° C., stirring the glass melt in the crucible by a platinum rod for 2 hours in order to let all compositions uniformly mix together in a homogeneous state, then pouring the glass melt onto a metal molding plate for cooling the glass melt into a flat glass plate. Meanwhile, after analyzing the flat glass plates obtained from the above procedures, the properties of the expansion coefficients, values of strain point, densities and glass liquidus temperatures of the flat glass plates are obtained and listed in the corresponding columns of Tables 1 and 2.

In the present invention, the properties of the expansion coefficients, values of strain point, densities and glass liquidus temperatures of the above flat glass plates were measured by utilizing the following procedures:

1) The expansion coefficients were measured by following the measuring standard of the code number E228-95 stipulated by American Society for Testing and Materials (ASTM), and were implemented by using mechanical push rod type thermal expansion meter and aluminum oxide, of which the temperature ranged from room temperature to the temperature causing the glass no more expanded or even shrunk due to softening, and the temperature raised at a rate 3° C. per minute. Eventually, the expansion coefficient was measured from calculating the expansion amount of the glass from the temperature 100° C. to 400° C.;

2) The values of strain point were measured by following the measuring standard of the code number C598-93 stipulated by American Society for Testing and Materials (ASTM), by heating and measuring the relationship between the distortion rates and temperatures of the glass samples and using the temperatures corresponding to the specific distortion rates as the strain points thereof;

3) The densities were measured by following the measuring standard of the code number C729-75 stipulated by American Society for Testing and Materials (ASTM), by taking 2 gram weight of block shaped glass without having bubble therein and obtaining the density by measuring the degrees of floating or sinking of the glass samples in the gravity fluid;

4) The glass liquidus temperatures were measured by following the measuring standard of the code number C829-81 stipulated by American Society for Testing and Materials (ASTM), by putting the glass powder of the size smaller than 850 μm into platinum crucible, heating the platinum crucible in a furnace having a region of gradient temperatures for at least 24 hours, and then determining the liquidus temperatures by using microscope to observe the devitrification inside the glass.

TABLE 1

| | Embodiment | | | | | |
|---|---|---|---|---|---|---|
| | 1 | 2 | 3 | 4 | 5 | 6 |
| Weight percent of SiO₂ | 58.0 | 57.0 | 58.0 | 58.3 | 56.5 | 59.5 |
| Weight percent of Al₂O₃ | 14.5 | 14.0 | 13.5 | 15.5 | 13.5 | 16.0 |
| Weight percent of B₂O₃ | 11.0 | 12.5 | 13.0 | 9.5 | 9.5 | 10.0 |
| Weight percent of SrO | 6.5 | 6.5 | 5.5 | 4.0 | 7.0 | 4.0 |
| Weight percent of BaO | 3.5 | 3.0 | 4.5 | 6.5 | 7.5 | 3.0 |
| Weight percent of CaO | 5.5 | 5.0 | 4.0 | 4.5 | 4.8 | 6.0 |
| Weight percent of MgO | 0 | 0.5 | 0 | 0.5 | 0.5 | 0.5 |
| Weight percent of ZnO | 0.5 | 1.0 | 0.5 | 0.2 | 0.5 | 0.5 |
| Weight percent of ZrO₂ | 0.5 | 0.5 | 1.0 | 0.5 | 0.2 | 0.5 |
| Weight percent of BeO | 0 | 0 | 0 | 0.5 | 0 | 0 |
| Weight percent of | 6.5 | 7.0 | 5.5 | 6.2 | 6.0 | 7.5 |
| MgO + CaO + ZnO + ZrO₂ + BeO | | | | | | |
| Expansion Coefficient | 38.6 | 38.9 | 37.4 | 39.4 | 38.3 | 39.1 |
| (10⁻⁷/° C.) | | | | | | |
| Strain point (° C.) | 656 | 658 | 655 | 660 | 652 | 661 |
| density (g/cm³) | 2.52 | 2.53 | 2.54 | 2.54 | 2.54 | 2.52 |
| glass liquidus temperatures | 1030 | 1035 | 1035 | 1030 | 1035 | 1030 |
| (° C.) | | | | | | |

From the data measured in embodiments 1 to 6 as shown in Table 1, it can be clearly observed that all the glass substrates manufactured according to this invention have the glass liquidus temperatures below 1045° C., which enables the glass more suitably being formed by using pull-down forming process and utilized to manufacture the substrate for flat plate display. In addition, since all the glass substrates manufactured according to this invention have expansion coefficients below 40×10⁻⁷/° C., strain points greater than 650° C. and densities below 2.55 g/cm³, of which the physical properties are similar to the substrate glass being used to manufacture the traditional liquid crystal display. Thus, the glass substrates manufactured according to this invention provide an appropriate material for manufacturing the traditional liquid crystal display.

Besides, this invention also show other comparative examples 7 to 12 with the conventional compositions other than this invention in Table 2. Among these comparative examples, it also clearly be observed that all the substrate being manufactured in Table 2 have the glass liquidus temperatures greater than 1045° C., therefore, it is easy to cause the glass having the problems of devitrification inside the glass formed by implementing the pull-down forming process. In addition, from the measured data shown in Table 2, it is also clear that the substrate glass manufactured in comparative example 7 having a thermal coefficient greater than normal, whereas the substrate glass manufactured in comparative examples 9, 10 and 11 having strain points less than normal, the substrate glass manufactured in comparative examples 8, 11 and 12 having densities greater than normal, all of them are not suitable to be the material for manufacturing the traditional liquid crystal display.

TABLE 2

| | Comparative example | | | | | |
|---|---|---|---|---|---|---|
| | 7 | 8 | 9 | 10 | 11 | 12 |
| Weight percent of SiO₂ | 58.0 | 54.0 | 57.2 | 57.0 | 57.0 | 63.0 |
| Weight percent of Al₂O₃ | 12.0 | 15.5 | 14.5 | 15.5 | 14.0 | 13.5 |
| Weight percent of B₂O₃ | 9.5 | 11.5 | 14.5 | 11.5 | 9.5 | 9.5 |
| Weight percent of SrO | 7.0 | 8.5 | 2.3 | 5.5 | 4.0 | 9.0 |
| Weight percent of BaO | 3.5 | 3.5 | 1.5 | 3.0 | 9.0 | 1.0 |
| Weight percent of CaO | 9.0 | 6.0 | 6.0 | 5.0 | 4.0 | 4.0 |
| Weight percent of MgO | 0.5 | 0 | 2.0 | 0 | 0 | 0 |
| Weight percent of ZnO | 0.5 | 0.5 | 1.0 | 2.5 | 0 | 0 |
| Weight percent of ZrO₂ | 0 | 0.5 | 0.5 | 0 | 2.5 | 0 |
| Weight percent of BeO | 0 | 0 | 0.5 | 0 | 0 | 0 |
| Weight percent of | 10.0 | 7.0 | 10.0 | 7.5 | 6.5 | 4.0 |
| MgO + CaO + ZnO + ZrO₂ + BeO | | | | | | |
| Expansion Coefficient (10⁻⁷/° C.) | 40.2 | 39.8 | 39.4 | 37.8 | 38.3 | 37.6 |
| Strain Point (° C.) | 656 | 650 | 647 | 645 | 644 | 665 |
| Density (g/cm³) | 2.55 | 2.56 | 2.53 | 2.55 | 2.58 | 2.56 |
| Glass Liquidus Temperature (° C.) | 1095 | 1100 | 1100 | 1110 | 1090 | 1110 |

Comparing the measured data between Table 1 and Table 2, It is apparent that all the glass substrates manufactured according to this invention have the glass liquidus temperatures below 1045° C., expansion coefficients below 40×10⁻⁷/° C., strain points greater than 650° C. and maintain densities below 2.55 g/cm³, of which the physical properties are similar to the general aluminosilicate glass being used to manufacture the traditional liquid crystal display. Thus, the glass substrates manufactured according to this invention indeed provide an appropriate material for manufacturing the traditional liquid crystal display.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A glass composition of a substrate for display consisting essentially of, as calculated in weight percent on an oxide basis:
56.0˜62.0% SiO sub.2;
13.0˜18.0% Al sub.2 O sub.3;
9.0˜13.5% B sub.2 O sub.3,
1.0˜8.0% SrO;
0.1˜8.0% BaO; and
3.5˜8.5% CaO.

2. A glass composition in accordance with claim 1 in which said substrate is manufactured by first uniformly mixing said compositions together; then putting said mixed compositions into a glass melting crucible; until said mixed compositions being melted into glass melt, reducing the temperature of said glass melt to a range necessary for forming said substrate, i.e. the temperature maintaining the viscosity within 10^{4.6}˜10^{5.2} poise; then utilizing the pull-down forming process to form substrate with a predetermined thickness and, after the temperature of said substrate being cooled down, cutting said substrate into pieces of a size appropriate for manufacturing said display.

3. A glass composition in accordance with claim 2, wherein said glass composition further includes 0˜1.0% MgO in weight percent.

4. A glass composition in accordance with claim 2, wherein said glass composition further includes 0.1˜1.5% ZnO in weight percent.

5. A glass composition in accordance with claim 2, wherein said glass composition further includes 0.1˜1.5% ZrO sub.2 in weight percent.

6. A glass composition in accordance with claim 2, wherein said glass composition further includes 0˜1.0% BeO in weight percent.

7. A glass composition in accordance with claim 3, wherein said glass composition further includes 0.1˜1.5% ZnO in weight percent.

8. A glass composition in accordance with claim 3, wherein said glass composition further includes 0.1˜1.5% ZrO sub.2 in weight percent.

9. A glass composition in accordance with claim 37 wherein said glass composition further includes 0˜1.0% BeO in weight percent.

10. A glass composition in accordance with claim 4, wherein said glass composition further includes 0.1˜1.5% ZrO sub.2 in weight percent.

11. A glass composition in accordance with claim 4, wherein said glass composition further includes 0˜1.0% BeO in weight percent.

12. A glass composition in accordance with claim 5, wherein said glass composition further includes 0˜1.0% BeO in weight percent.

13. A glass composition in accordance with claim 7, wherein said glass composition further includes 0.1˜1.5% ZrO sub.2 in weight percent.

14. A glass composition in accordance with claim 7, wherein said glass composition further includes 0˜1.0% BeO in weight percent.

15. A glass composition in accordance with claim 12, wherein said glass composition further includes 0.1˜1.5% ZnO in weight percent.

16. A glass composition in accordance with claim 15, wherein the total weight percent of CaO, MgO, ZnO, ZrO sub.2 and BeO is preferably within 4.0˜9.0%
